(19) United States
(12) Patent Application Publication
(10) Pub. No.: US 2013/0148857 A1
(43) Pub. Date: Jun. 13, 2013

(54) APPARATUS FOR EXTRACTING CHARACTER AREA IN VEHICLE NUMBER PLATE AND METHOD THEREOF

(71) Applicants: Young Woo YOON, Daejeon (KR); Ho Sub YOON, Daejeon (KR); Kyu Dae BAN, Daejeon (KR); Jae Hong KIM, Daejeon (KR); Joo Chan SOHN, Daejeon (KR)

(72) Inventors: Young Woo YOON, Daejeon (KR); Ho Sub YOON, Daejeon (KR); Kyu Dae BAN, Daejeon (KR); Jae Hong KIM, Daejeon (KR); Joo Chan SOHN, Daejeon (KR)

(73) Assignee: Electronics and Telecommunications Research Institute, Daejeon (KR)

(21) Appl. No.: 13/534,379

(22) Filed: Jun. 27, 2012

(30) Foreign Application Priority Data
Dec. 12, 2011 (KR) 10-2011-0133265

(51) Int. Cl. G06K 9/18

(52) U.S. Cl. 382/105

(57) ABSTRACT

Disclosed are an apparatus for extracting a character area in a vehicle number plate and a method thereof. An apparatus for extracting a character area in a vehicle number plate according to an exemplary embodiment of the present invention includes a candidate area extracting unit configured to extract a plurality of character candidate areas from a vehicle number plate image using a plurality of algorithms; a filtering unit configured to determine a final character candidate area from the plurality of extracted character candidate areas; and a character area selecting unit configured to select a final character area from the final character candidate area using geometric information of blobs.

### CROSS-REFERENCE TO RELATED APPLICATIONS

This application claims priority to and the benefit of Korean Patent Application No. 10-2011-0133265 filed in the Korean Intellectual Property Office on Dec. 12, 2011, the entire contents of which are incorporated herein by reference.

### TECHNICAL FIELD

The present invention relates to a method for recognizing a vehicle number plate, and more specifically, to an apparatus for extracting a character area in a vehicle number plate that extracts a plurality of character candidate areas from an image obtained by capturing the number plate using different algorithms and filters the plurality of extracted character areas using a character recognizing unit to select a final character area and a method thereof.

### BACKGROUND ART

An automatic number plate recognition system that uses a camera image detects a vehicle number area from the image, extracts character or number areas from the detected number plate, and then recognizes the extracted character or number.

Specifically, according to a method of extracting a character or number area from the plate area in a related art, representatively, the number plate image is binarized and a noise area is removed from the binarized number plate image by a connected component analysis to separate a desired character or number.

According to the related art, the reliability is high when the number plate image is clear and the resolution is high. However, if the resolution is low or foreign substance is attached on the number plate, it is difficult to separate the character area using the binarization because the adjacent number areas are combined with each other or one number area is divided into plural areas due to the image noise.

Alternatively, local binarization that binarizes the number plate area by dividing the areas in the number plate image or morphology operation that expands or reduces the binarized areas may be used to increase performance of extracting the character area, but the methods also have some restrictions.

### SUMMARY OF THE INVENTION

The present invention has been made in an effort to provide an apparatus for extracting a character area in a vehicle number plate that extracts a plurality of character candidate areas from an image obtained by capturing the number plate using different algorithms and filters the plurality of extracted character areas using a character recognizing unit to select a final character area and a method thereof.

However, the object of the present invention is not limited to the above-mentioned matters, and the other objects which are not described may be clearly understood by those skilled in the art on the basis of the following description.

An exemplary embodiment of the present invention provides an apparatus for extracting a character area in a vehicle number plate, including: a candidate area extracting unit configured to extract a plurality of character candidate areas from a vehicle number plate image using a plurality of algorithms; a filtering unit configured to determine a final character candidate area from the plurality of extracted character candidate areas; and a character area selecting unit configured to select a final character area from the final character candidate area using geometric information of blobs.

The plurality of algorithms may be different algorithms.

The plurality of algorithms may be at least one algorithm having different set parameter values.

The candidate area extracting unit may binarize the number plate image using the plurality of algorithms and extract connected blobs from the binarized image using CCA (connected component analysis) as the character candidate area.

The filtering unit may filter areas or blobs other than characters in the plurality of character candidate areas using character recognition to determine the final character candidate area using the filtering result.

The filtering unit may perform character recognition for the extracted character candidate areas to calculate a matching score using the character recognition result, and determine the final character candidate area from the plurality of character candidate areas based on the matching score.

The filtering unit may remove blobs having a matching score lower than a predetermined threshold for character candidate areas which do not overlap.

The filtering unit may select a blob having a highest matching score for character candidate areas which overlap each other.

The geometric information may include at least one of the position of the blob and the size of the blob.

Another exemplary embodiment of the present invention provides a method of extracting a character area in a vehicle number plate, including: extracting a plurality of character candidate areas from a vehicle number plate image using a plurality of algorithms; determining a final character candidate area from the plurality of extracted character candidate areas; and selecting a final character area from the final character candidate area using geometric information of blobs.

The plurality of algorithms may be different algorithms.

The plurality of algorithms may be at least one algorithm having different set parameter values.

The extracting may binarize the number plate image using the plurality of algorithms and extract connected blobs from the binarized image using CCA (connected component analysis) as the character candidate area.

The determining may filter areas or blobs other than characters in the plurality of character candidate areas using character recognition to determine the final character candidate area using the filtering result.

The determining may perform character recognition for the extracted character candidate areas to calculate a matching score using the character recognition result and determine the final character candidate area from the plurality of character candidate areas based on the matching score.

The determining may remove blobs having a matching score lower than a predetermined threshold for character candidate areas which do not overlap.

The determining may select a blob having a highest matching score for character candidate areas which overlap each other.

The geometric information may include at least one of the position of the blob and the size of the blob.

According to exemplary embodiments of the present invention, by extracting a plurality of character candidate areas from an image obtained by capturing a vehicle number plate using different algorithms and filtering the plurality of extracted character areas using a character recognizing unit to select a final character area, a character area is accurately extracted from a number plate image with low resolution or a noise.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram for illustrating an apparatus for extracting a character area according to an exemplary embodiment of the present invention.

FIGS. 2A to 2F are diagrams for illustrating a process of extracting a character candidate area according to an exemplary embodiment of the present invention.

FIGS. 3A and 3B are diagrams for illustrating a process of determining a final character candidate area according to an exemplary embodiment of the present invention.

FIG. 4 is a diagram for illustrating a process of selecting a final character candidate area according to an exemplary embodiment of the present invention.

FIG. 5 is a diagram illustrating a method of extracting a character area according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

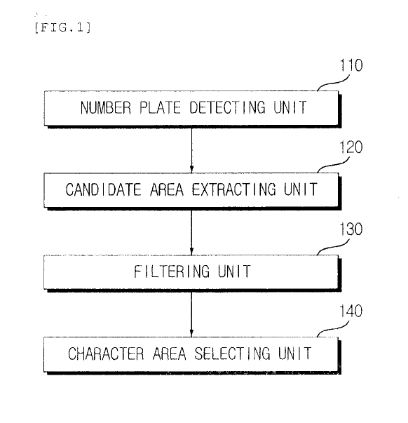

Hereinafter, an apparatus for extracting a character area from a vehicle number plate and a method thereof according to an exemplary embodiment of the present invention will be described in detail with reference to FIGS. 1 to 5. The detailed description will be made mainly in order to understand the operations and functions of the present invention. In the following description and drawings, reference numbers refer to the same or equivalent parts of the present invention throughout the several figures of the drawing whose repeated description will be omitted. However, if it is considered that description of related known configuration or function may cloud the gist of the present invention, the description will be omitted.

The exemplary embodiment of the present invention suggests a method of extracting a plurality of character candidate areas from an image obtained by capturing a vehicle number plate using different algorithms and filtering the plurality of extracted character candidate areas using a character recognizing unit to select a final character area. Here, the character may be a comprehensive concept that includes Korean alphabets, alphabets, Chinese characters, or numbers.

FIG. 1 shows a diagram illustrating an apparatus for extracting a character area according to an exemplary embodiment of the present invention.

As shown in FIG. 1, an apparatus for extracting a character area according to the exemplary embodiment of the present invention includes a number plate detecting unit 110, a candidate area extracting unit 120, a filtering unit 130, and a character area selecting unit 140.

The number plate detecting unit 110 receives an image captured by a camera and detects a number plate image including a number plate area from the received image. Here, the number plate image may be an image in which tilting of the number plate caused by the capturing direction of the camera is corrected.

The candidate area extracting unit 120 extracts a plurality of character candidate areas from the detected number plate image using different algorithms or at least one algorithm having different set parameter values. Specifically, when binarization method is used as the algorithm, the candidate area extracting unit 120 binarizes the number plate image using different algorithms and extracts a connected blob in the binarized image using CCA (connected component analysis) as a character candidate area.

In this case, the accuracy of character area extracting depends on how to preferably create the binarized image. Therefore, the exemplary embodiment of the present invention extracts a plurality of character candidate areas using various binarization methods. The binarization method may include Otsu binarization, Niblack binarization, or Sauvola binarization and these binarizations may be complementary to each other.

For example, the candidate area extracting unit 120 1) extracts three character candidate areas using Otsu binarization, Niblack binarization, and Sauvola binarization, or 2) extracts three character candidate areas using Niblack binarization having different set parameter values.

The present invention suggests a method of extracting characters or numbers using the above binarization methods. However, the invention is not limited thereto, but may use various methods that can extract characters or numbers such as a projection method.

Various binarization methods may be used to extract characters or numbers from a binarized image using the CCA because the characters or numbers are connected to each other.

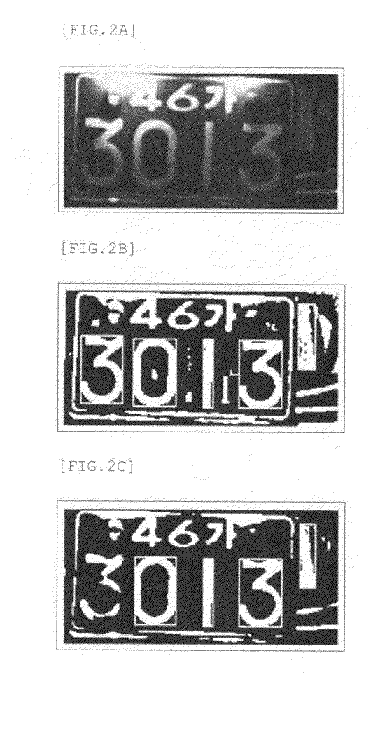

FIGS. 2A to 2F are diagrams for illustrating a process of extracting a character candidate area according to an exemplary embodiment of the present invention.

FIG. 2A shows a number plate image and FIGS. 2B to 2F show images in which character areas are extracted using different algorithms. Here, it is assumed that numbers 3, 0, 1, and 3 are extracted from the number plate image.

For example, binarized images shown in FIGS. 2B to 2E are obtained using Niblack binarization having different set parameter values, and rectangle blobs corresponding to numbers 3, 0, 1, and 3 are detected from the binarized image. Blobs for areas other than the numbers are also detected.

In this case, the parameter value is a value for determining criteria for binarization, for example, may be a threshold for discriminating 0 and 1.

It is understood that rectangle blobs corresponding to numbers 0, 1, and 3 are detected from the binarization image as shown in FIG. 2C. Blobs of area other than the numbers are also detected.

It is also understood that rectangle blobs corresponding to numbers 3, 0, 1, and 3 are detected from the binarization image as shown in FIG. 2D. Blobs of area other than the numbers are also detected.

It is also understood that rectangle blobs corresponding to numbers 3, 0, 1, and 3 are detected from the binarization image as shown in FIG. 2E. Blobs of area other than the numbers are also detected.

In other words, FIGS. 2B to 2E show that binarized images are created using binarization method having different set parameter values and number candidate areas are extracted from the created binarized image using CCA.

FIG. 2F shows that rectangle blobs corresponding to numbers 4, 3, 0, and 3 are extracted from the number plate image using an appearance based number detecting method.

The filtering unit 130 filters areas or blobs other than numbers from the plurality of extracted character candidate areas using character recognition and determines a final character candidate area using the filtering result. This is because if excessively large amount of character candidate areas are created, it is difficult to select a final character candidate area from the plurality of character candidate areas.

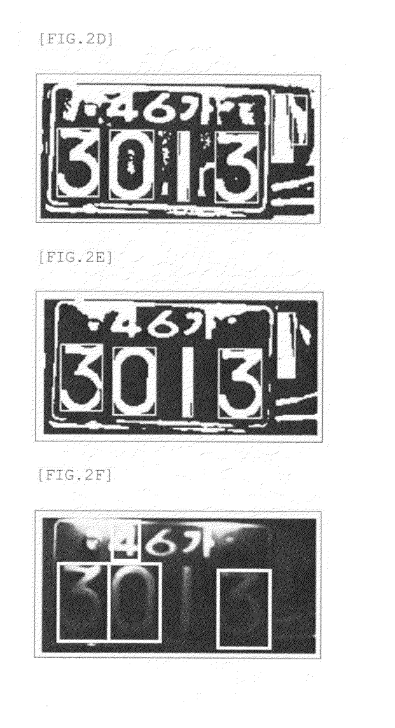

FIGS. 3A and 3B are diagrams for illustrating a process of determining a final character candidate area according to an exemplary embodiment of the present invention.

FIG. 3A shows all character candidate areas extracted in FIGS. 2A to 2F. The filtering unit 130 performs character recognition for the character candidate areas and calculates a matching score using the character recognition result. Here, the matching score indicates how the corresponding blob is closely recognized for a character.

FIG. 3B shows a final character candidate area determined among the plurality of character candidate areas. That is, the filtering unit 130 removes blobs having a matching score lower than a predetermined threshold for character candidate areas which do not overlap and removes blobs other than a blob having a highest matching score for character candidate areas which overlap each other.

Therefore, final character candidate areas corresponding to numbers 4, 3, 0, 1, and 3 may be determined.

As described with reference to FIGS. 2 and 3, the exemplary embodiment of the present invention creates more character candidate areas using one or more different algorithms and filters the character candidate areas using the character recognition to determine a final character candidate area.

The character area selecting unit 140 selects a final character area in a determined final character candidate area using geometric information of the blobs.

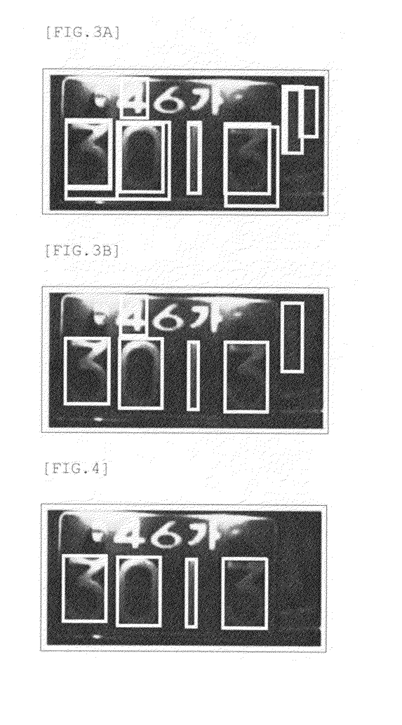

FIG. 4 is a diagram for illustrating a process of selecting a final character candidate area according to an exemplary embodiment of the present invention.

As shown in FIG. 4, the character area selecting unit 140 selects a final character area using the geometric information of the blobs, for example, a position or a size of the blobs. For example, the character area selecting unit 140 determines that the numbers are disposed in a straight line in the final character candidate area using the positions of the blobs to select the final character areas 3, 0, 1, and 3.

This is because the characters in the vehicle number plate have a constant size, interval, or space.

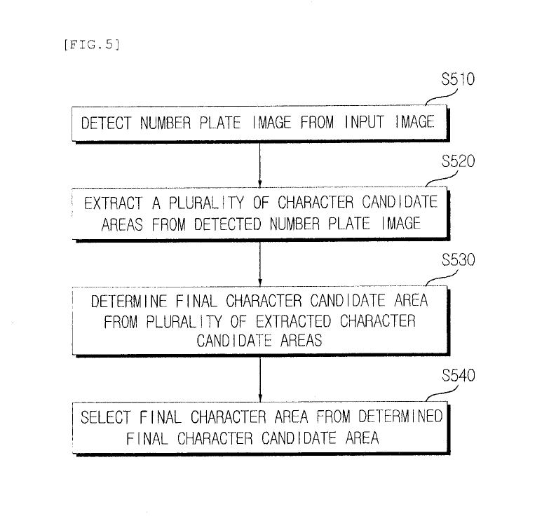

FIG. 5 is a diagram for illustrating a method of extracting a character area according to an exemplary embodiment of the present invention.

As shown in FIG. 5, when an image captured by a camera is input, an apparatus for extracting a character area according to the exemplary embodiment of the present invention (hereinafter, referred to as a character area extracting apparatus) detects a number plate image including a number plate area from the input image (S510).

Next, the character area extracting apparatus extracts a plurality of character candidate areas from the detected number plate image using a plurality of algorithms (S520). Here, the plurality of algorithms may be different algorithms or at least one algorithm having different set parameter values.

Next, the character area extracting apparatus filters areas or blobs other than characters from the plurality of extracted character candidate areas using character recognition to determine a final character candidate area using the filtering result (S530).

That is, the character area extracting apparatus performs character recognition for the character candidate areas and calculates a matching score using the character recognition result to determine a final character candidate area based on the calculated matching score. In this case, the character area extracting apparatus removes blobs having a matching score lower than a predetermined threshold for character candidate areas which do not overlap and removes blobs other than a blob having a highest matching score for character candidate areas which overlap each other.

Next, the character area extracting apparatus selects a final character area in a determined final character candidate area using geometric information of the blobs such as a position or a size of the blob (S540).

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for extracting a character area in a vehicle number plate, comprising:
a candidate area extracting unit configured to extract a plurality of character candidate areas from a vehicle number plate image using a plurality of algorithms;
a filtering unit configured to determine a final character candidate area from the plurality of extracted character candidate areas; and
a character area selecting unit configured to select a final character area from the final character candidate area using geometric information of blobs.

2. The apparatus of claim 1, wherein the plurality of algorithms are different algorithms.

3. The apparatus of claim 1, wherein the plurality of algorithms are at least one algorithm having different set parameter values.

4. The apparatus of claim 1, wherein the candidate area extracting unit binarizes the number plate image using the plurality of algorithms and extracts connected blobs from the binarized image using CCA (connected component analysis) as the character candidate area.

5. The apparatus of claim 1, wherein the filtering unit filters areas or blobs other than characters in the plurality of character candidate areas using character recognition to determine the final character candidate area using the filtering result.

6. The apparatus of claim 1, wherein the filtering unit performs character recognition for the extracted character candidate areas to calculate a matching score using the character recognition result, and
determines the final character candidate area from the plurality of character candidate areas based on the matching score.

7. The apparatus of claim 6, wherein the filtering unit removes blobs having a matching score lower than a predetermined threshold for character candidate areas which do not overlap.

8. The apparatus of claim 6, wherein the filtering unit selects a blob having a highest matching score for character candidate areas which overlap each other.

9. The apparatus of claim 1, wherein the geometric information includes at least one of the position of the blob and the size of the blob.

10. A method of extracting a character area in a vehicle number plate, comprising:
extracting a plurality of character candidate areas from a vehicle number plate image using a plurality of algorithms;
determining a final character candidate area from the plurality of extracted character candidate areas; and
selecting a final character area from the final character candidate area using geometric information of blobs.

11. The method of claim 10, wherein the plurality of algorithms are different algorithms.

12. The method of claim 10, wherein the plurality of algorithms are at least one algorithm having different set parameter values.

13. The method of claim 10, wherein the extracting binarizes the number plate image using the plurality of algorithms and extracts connected blobs from the binarized image using CCA (connected component analysis) as the character candidate area.

14. The method of claim 10, wherein the determining filters areas or blobs other than characters in the plurality of character candidate areas using character recognition to determine the final character candidate area using the filtering result.

15. The method of claim 10, wherein the determining performs character recognition for the extracted character candidate areas to calculate a matching score using the character recognition result, and
determines the final character candidate area from the plurality of character candidate areas based on the matching score.

16. The method of claim 15, wherein the determining removes blobs having a matching score lower than a predetermined threshold for character candidate areas which do not overlap.

17. The method of claim 15, wherein the determining selects a blob having a highest matching score for character candidate areas which overlap each other.

18. The method of claim 10, wherein the geometric information includes at least one of the position of the blob and the size of the blob.
